(19) United States
(12) Patent Application Publication
(10) Pub. No.: US 2025/0019486 A1
(43) Pub. Date: Jan. 16, 2025

(54) PROCESS FOR PREPARING POLYOXYALKYLENE POLYESTER POLYOLS

(71) Applicant: Covestro Deutschland AG, Leverkusen (DE)

(72) Inventors: Klaus Lorenz, Dormagen (DE); Frank Kleinig, Dormagen (DE)

(21) Appl. No.: 18/695,992

(22) PCT Filed: Sep. 30, 2022
(86) PCT No.: PCT/EP2022/077271

§ 371 Date: Mar. 27, 2024

(30) Foreign Application Priority Data
Oct. 7, 2021 (EP) 21201406.2

(51) Int. Cl. C08G 18/48; C08G 18/42; C08G 18/46

(52) U.S. Cl. CPC C08G 18/4891; C08G 18/4244; C08G 18/4653

(57) ABSTRACT

The invention relates to a process for preparing polyoxyalkylene polyester polyols with calculated OH numbers of 320 mg (KOH)/g to 530 mg (KOH)/g by reacting a starter compound, which contains alcoholic hydroxy groups and/or amine protons, and a fatty acid ester containing an alkylene oxide. The invention further relates to polyoxyalkylene polyester polyols resulting from the method and to a preparation method for polyurethanes by reaction of the polyoxyalkylene polyester polyols according to the invention with polyisocyanates.

The present invention relates to a process for preparing polyoxyalkylene polyester polyols having calculated OH numbers from 320 mg (KOH)/g to 530 mg (KOH)/g by reacting a starter compound having alcoholic hydroxy groups and/or aminic protons and a fatty acid ester with an alkylene oxide. The invention also further relates to polyoxyalkylene polyester polyols resulting from the process and to a process for preparing polyurethanes by reaction of the polyoxyalkylene polyester polyols according to the invention with polyisocyanates.

Polyols based on renewable raw materials such as fatty acid triglycerides, sugar, sorbitol, glycerol and dimer fatty alcohols are already used in a variety of ways as raw materials in the production of polyurethane materials. The use of such components will continue to increase in future, since products from renewable sources will be favorably assessed in life cycle assessments and the availability of raw materials based on petrochemicals will decrease in the long term. In addition, the targeted use of fatty acid esters in the preparation of alkylene oxide addition products based on starters having Zerewitinoff-active hydrogen atoms also makes it possible to obtain polyether ester polyols characterized by an increased dissolving power for blowing agents based on (partially halogenated) hydrocarbons and typically used in rigid foam formulations or generally by an elevated hydrophilicity of the materials produced therefrom.

EP 1923417 A1 discloses a single-stage process for preparing polyether ester polyols by reaction of starter compounds having Zerewitinoff-active hydrogen atoms (“H-functional starter compounds”) with alkylene oxides under base catalysis in the presence of fatty acid esters as a renewable raw material, wherein the fatty acid residues of the fatty acid esters contain no free OH groups. These polyether ester polyols are used as components in formulations with other polyols in the production of rigid PUR/PIR foams, wherein these PUR/PIR systems are characterized by good demolding characteristics.

WO 2013/016263 A2 describes a process for preparing amine-started polyether polyols, wherein the process partly employs renewable raw materials, and the use of such polyether polyols in the production of rigid polyurethane foams. The process comprises the reaction of an amine-based alkoxylation adduct with a triglyceride and optionally a polysaccharide, wherein both originate from renewable sources.

EP 2177555 A2 relates to a process for preparing polyetherester polyols starting from fatty acid esters and starter compounds having Zerewitinoff-active hydrogen atoms and the use thereof for production of solid or foamed polyurethane materials. The process ensures smooth takeup of the alkylene oxides metered in and these may therefore be added continuously. This process is especially suitable for preparing polyether ester polyols based on starter compounds having a melting point close to or above the customary reaction temperature, i.e. having a melting point above 100° C., or for preparing polyether ester polyols based on starter compounds having a tendency to decompose at the customary reaction temperature.

EP 2807199 A1 discloses a process for preparing a polyoxyalkylene polyether ester polyol by reacting a Zerewitinoff-active starter compound with fatty acid esters and alkylene oxides using basic imidazole catalysts, wherein preparation is additionally carried out in the presence of a cyclic anhydride of dicarboxylic acids. The resulting polyetherester polyols are likewise used in the production of rigid foams. It is thought that the presence of the aromatic dicarboxylic acid units in the polyoxyalkylene polyester polyol end product should lead to improved flame retardant properties.

WO 2021/122401 A1 discloses a process for preparing polyoxyalkylene polyester polyols by reaction of a starter compound having Zerewitinoff-active H atoms, a cyclic dicarboxylic anhydride and a fatty acid ester with an alkylene oxide in the presence of a basic catalyst to afford products which are less discolored.

However, the prior art processes proposed prove problematic when very hydrophobic polyoxyalkylene polyester polyols are to be prepared on the basis of starter compounds solid at room temperature and on the basis of fatty acid esters having OH numbers of not more than 100 mg (KOH)/g, in particular polyoxyalkylene polyester polyols having a fatty acid ester content of 40% by mass or more. It turns out that turbid or even multiphase end products often result, even when the process proposed in EP 2177555 A2 is used.

The object was surprisingly able to be achieved by a process for preparing a polyoxyalkylene polyester polyol having a calculated OH number of 320 mg KOH/g to 530 mg KOH/g, preferably of 350 mg KOH/g to 500 mg KOH/g, by reacting an H-functional starter compound (1) having n(1) mol of alcoholic hydroxy groups and/or aminic protons, preferably having n(1) mol of alcoholic hydroxy groups, and a fatty acid ester (2) having n(2) mol of fatty acid ester groups with an alkylene oxide (3), optionally in the presence of a basic catalyst (4) and optionally in a solvent (5), wherein the H-functional starter compound (1) comprises one or more compounds, wherein at least one H-functional starter compound (1) has a melting point of >50.0° C., preferably of >55.0° C., determined according to the method DIN EN ISO 11357-1:2016, wherein the fatty acid ester (2) has an OH number of less than 100 mg KOH/g, wherein the proportion of the fatty acid ester (2) is at least 40% by mass based on the total mass of the employed H-functional starter compound (1), the employed fatty acid ester (2) and the employed alkylene oxide (3), wherein the process comprises the steps of:
(i) providing a system (i) comprising the H-functional starter compound (1) and optionally the basic catalyst (4) optionally in a solvent (5) in a reaction vessel,
(ii) adding n(3−1) mol of a first sub-amount of the alkylene oxide (3) to the system (i) over a period t₁ to form an intermediate (ii),
(iii) removing any solvent (5) present from the intermediate (ii) to form an intermediate (iii), (iv) adding the fatty acid ester (2) to the intermediate (ii) or to the intermediate (iii) to form the intermediate (iv), wherein n(2) mol of fatty acid ester groups are supplied to the intermediate (ii) or the intermediate (iii),
(v) adding n(3−2) mol of a second sub-amount of the alkylene oxide (3) to the intermediate (iv) over a period t₂ to form the polyoxyalkylene polyester polyol,
wherein (n(3−2)/n(2))·t₂/[h]≥1.0; preferably 1.0≤(n(3−2)/n(2))·t₂/[h]≤10.0; particularly preferably 1.0≤(n(3−2)/n(2))·t₂/[h]≤8.0,
wherein n(2)/n(3−2)≥1.05; preferably 1.05≤n(2)/n(3−2)≤10.0; particularly preferably 1.25≤n(2)/n(3−2)≤6
and
wherein n(3−1)/n(1)≥0.43; preferably 0.43≤n(3−1)/n(1)≤0.92, particularly preferably 0.44≤n(3−1)/n(1)≤0.80.

The term “t₂/[h]” describes the numerical value of the period t₂ expressed in hours.

In the context of the present invention the term polyoxyalkylene polyester polyols is to be understood as meaning products of the reaction of starter compounds (1), fatty acid esters (2) and alkylene oxides (3), wherein the reaction of the fatty acid esters (2) affords ester units and the ring-opening products of the alkylene oxides (3) can also result in ether bonds. From the starter compound (1) with n(1) mol of alcoholic hydroxy groups and/or aminic protons, preferably having n(1) mol of alcoholic hydroxy groups, polyoxyalkylene polyester polyols with hydroxylene end groups are formed in such a process.

The term aminic protons is to be understood as meaning protons of ammonia, primary and secondary amines, wherein a primary amine having an NH₂ group provides two aminic protons, thus resulting in two alcoholic hydroxy groups by addition reaction of alkylene oxides according to the common general knowledge in the art. Analogously a secondary amine provides one aminic proton and ammonia three aminic protons.

According to the invention the term alcoholic hydroxy groups is to be understood as meaning hydroxy groups of an alcohol of formula R—OH, wherein R is an alkyl, aryl or cycloalkyl group and R is not H (hydrogen). The alcoholic hydroxy group provides an alcoholic proton, this in turn also resulting in an alcoholic hydroxy group by addition reaction of alkylene oxides according to the common general knowledge in the art. The number of mol n(1) of alcoholic hydroxy groups introduced by the starter compound is calculated as follows:

$$n ( 1 ) = {\sum }_{i = 1}^{i = n} {n}_{i} \times {F}_{i}$$

where: nᵢ=employed number of moles of starter component i
   Fᵢ=hydroxy functionality of starter component i

The number of mol n(1) of alcoholic hydroxy groups formed from aminic starter compounds is calculated as follows:

$$n ( 1 ) = {\sum }_{j = 1}^{j = n} {n}_{j} \times {F}_{j}$$

where: nⱼ=employed number of moles of aminic starter component j
   Fⱼ=number of aminic protons introduced by the aminic starter component j per molecule

The OH number of the polyoxyalkylene polyester polyol according to the invention is calculated as follows (OHN_{calc}). The OHN is reported in mg KOH/g

$${OHN}_{calc} = \frac{{Σ}_{i} {mi}_{i} \times {OHN}_{i} + {Σ}_{j} {m}_{j} \times {OHN}_{j} + {Σ}_{f} {m}_{f} \times {OHN}_{f}}{Batch mass}$$

where: batch mass=sum of the masses of all added components minus the mass of the solvent optionally separated in step (iii)
   mᵢ=mass of the hydroxy-functional starter component i
   mⱼ=mass of the amine-functional starter component j
   m_{f}=mass of the fatty acid ester f
   OHNᵢ=OH number of the starter component i
   OHNⱼ=effective OH number of the aminic starter component j
   OHN_{f}=OH number of the fatty acid ester f

The OH-numbers of hydroxy-functional starter components (OHNᵢ) and the OH-numbers of the fatty acid esters (OHN_{f}) may be calculated according to the following formulae provided that the molar masses Mᵢ and the hydroxy functionalities Fᵢ of the starter components and the molar masses M_{f} and the hydroxy functionalities F_{f} of the fatty acid esters are known:

$${OHN}_{i} = \frac{56 \; 100 \times {F}_{i}}{{M}_{i}} \\ {OHN}_{f} = \frac{56 \; 100 \times {F}_{f}}{{M}_{f}}$$

It is accordingly possible to calculate the effective OH number (OHNⱼ) for aminic starter compounds according to the following formula when the number Fⱼ of aminic protons introduced per molecule by the aminic starter component j and the molar mass Mⱼ of the aminic starter compound j are known:

$${OHN}_{j} = \frac{56 \; 100 \times {F}_{j}}{{M}_{j}}$$

If Mᵢ, Fᵢ, M_{f} and/or F_{f} are not known, which may especially often be the case for F_{f} and M_{f}, the corresponding OH numbers OHNᵢ and OHN_{f} may also be determined by titrimetric methods, for example according to the specification of DIN 53240.

The following discloses embodiments according to the invention which may be combined with one another as desired provided the opposite is not apparent from the technical context.

In the context of the present invention the term H-functional_starter compounds (1) is to be understood as meaning compounds comprising at least one alcoholic hydroxy group and/or at least one aminic proton, preferably at least one alcoholic hydroxy group.

According to the invention the H-functional starter compound (1) comprises one or more compounds, wherein at least one (first) H-functional starter compound (1) has a melting point determined according to the method DIN EN ISO 11357-1:2016 of >50.0° C., preferably of >55.0° C.

Suitable H-functional starter compounds (“starters”) preferably have functionalities of 2 to 8, but in particular cases also functionalities up to 35. The molar masses thereof are from 17 g/mol to 1200 g/mol.

In one embodiment of the process according to the invention, the (first) starter compound (1) has a melting point of above 65° C., preferably of 65° C. to 265° C. and particularly preferably of 80° C. to 180° C.

In a preferred embodiment of the process according to the invention, the (first) H-functional starter compound (1) having the melting point of >50.0° C. is one or more compounds selected from the group consisting of trimethylolpropane, pentaerythritol, sorbitol, sucrose, hydroquinone, catechol, resorcinol, bisphenol F, bisphenol A, 1,3,5-trihydroxybenzene, 1,12-dodecanediol, the isomers of diaminotoluene, the isomers of diaminodiphenylmethane, preferably from the group consisting of pentaerythritol, sorbitol and sucrose.

The (first) H-functional starter compound (1) having the melting point of >50.0° C. is used either individually or as a mixture of at least two (first) H-functional starter compounds (1).

In one embodiment of the process according to the invention, the H-functional starter compound (1) further comprises at least one second H-functional starter compound having a melting point of ≤50° C.

In a preferred embodiment of the process according to the invention, the second H-functional starter compound having a melting point of ≤50° C. is one or more compounds selected from the group consisting of propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, glycerol, triethanolamine, ammonia, ethanolamine, diethanolamine, isopropanolamine, diisopropanolamine, ethylenediamine, hexamethylenediamine, aniline and the isomers of toluidine, preferably of propylene glycol, ethylene glycol and glycerol.

The (second) H-functional starter compound (1) having the melting point of ≤50° C. is used either individually or as a mixture of at least two (second) H-functional starter compounds (1).

In one embodiment of the process according to the invention, the mass ratio of the employed second H-functional starter compound having a melting point<50° C. to the employed first H-functional starter compound having a melting point of ≥50° C. is from 0.1:1 to 0.5:1, preferably from 0.2:1 to 0.4:1.

The umbrella term “fatty acid esters” hereinbelow refers to fatty acid glycerides, especially fatty acid triglycerides, and/or fatty acid esters based on other mono- and polyfunctional alcohols or mixtures of such fatty acid esters/fatty acid glycerides. The fatty acid residues of the fatty acid esters may, as is the case in castor oil, themselves bear hydroxyl groups. It goes without saying that it is also possible to use fatty acid esters whose fatty acid residues have subsequently been modified with hydroxyl groups in the process according to the invention. Fatty acid residues that have been modified in this way may be obtained, for example, by epoxidation of the olefinic double bonds and subsequent ring opening of the oxirane rings using nucleophiles or by hydroformylation/hydrogenation. It is also possible to treat unsaturated oils with atmospheric oxygen for this purpose, frequently at elevated temperature.

All triglycerides are suitable as substrates for the processes according to the invention. Examples include cottonseed oil, peanut oil, coconut oil, linseed oil, palm kernel oil, olive oil, corn oil, palm oil, castor oil, lesquerella oil, rapeseed oil, soybean oil, sunflower oil, herring oil, sardine oil and tallow. The fatty acid (tri)glycerides and the fatty acid esters of other mono- and polyfunctional alcohols may also be used in the mixture. The OH number of such a fatty acid ester/fatty acid ester mixture is not more than 100 mg (KOH)/g.

In one embodiment of the process according to the invention, the fatty acid ester (2) has no free hydroxyl groups in the fatty acid residues.

In one embodiment of the process according to the invention, the fatty acid ester (2) is one or more compounds selected from the group consisting of cottonseed oil, peanut oil, coconut oil, linseed oil, palm kernel oil, olive oil, corn oil, palm oil, jatropha oil, rapeseed oil, soybean oil, sunflower oil, herring oil, sardine oil and tallow, preferably soybean oil.

The fatty acid esters (2) are used either individually or as a mixture of at least two fatty acid esters.

According to the invention, the proportion of the fatty acid ester (2) is at least 40% by mass based on the total mass of the employed H-functional starter compound (1), the employed fatty acid ester (2) and the employed alkylene oxide (3).

In a preferred embodiment of the method according to the invention, the proportion of the fatty acid ester (2) is from 40% by mass to 60% by mass, preferably from 42% by mass to 58% by mass and particularly preferably from 45% by mass to 55% by mass based on the total mass of the employed H-functional starter compound (1), the employed fatty acid ester (2) and the employed alkylene oxide (3).

Suitable alkylene oxides (3) are, for example, ethylene oxide, propylene oxide, 1,2-butylene oxide/2,3-butylene oxide and styrene oxide. It is preferable when propylene oxide and ethylene oxide are supplied to the reaction mixture individually, in admixture or successively. If the alkylene oxides are metered in successively, the products prepared contain polyether chains having block structures. For example, step (v) may comprise metered addition of an alkylene oxide other than that added in step (ii). Products having ethylene oxide end blocks are generally characterized by elevated concentrations of primary end groups, which impart the systems with an optionally required higher isocyanate-reactivity. Preferably employed alkylene oxides are propylene oxide and/or ethylene oxide, particularly preferably propylene oxide.

In one embodiment of the process according to the invention the alkylene oxide (3) is propylene oxide and/or ethylene oxide, preferably propylene oxide.

The alkylene oxides (3) are employed either individually or as a mixture of at least two alkylene oxides.

### Basic Catalyst (4)

In one embodiment of the process according to the invention, the basic catalyst (4) is added in step (i) and/or in step (iv). The basic catalyst is preferably added in step (i).

In one embodiment of the process according to the invention, the basic catalyst used is an alkali metal or alkaline earth metal hydroxide, preferably potassium hydroxide. The catalyst may be added to the reaction mixture in the form of aqueous solutions or in anhydrous form. Any water of solution present or water formed by the deprotonation of the OH groups is preferably removed before the fatty acid esters are added to the reaction mixture. The dehydration may be carried out, for example, by heat-treating under reduced pressure at temperatures of 80° C. to 150° C. and optionally assisted by stripping with inert gas. The catalyst concentration here is preferably 0.02% to 1% by mass, based on the amount of end product, particularly preferably 0.05% to 0.6% by mass is employed.

In a more preferred embodiment of the process according to the invention, the reaction in step (i) and/or in step (iv), preferably in step (i), is carried out in the presence of a basic catalyst (4), wherein the basic catalyst is preferably an amine, preferably an aromatic amine.

In a particularly preferred embodiment of the process according to the invention, the amine is an aromatic amine and the aromatic amine is one or more compounds selected from the group consisting of imidazole, 1-methylimidazole, 2-methylimidazole, 4(5)-methylimidazole, 2,4(5)-dimethylimidazole, 1-ethylimidazole, 2-ethylimidazole, 1-phenylimidazole, 2-phenylimidazole, 4(5)-phenylimidazole, and N,N-dimethylaminopyridine.

A comprehensive overview of amines that may be used has been given by M. Ionescu et al. in “Advances in Urethanes Science and Technology”, 1998, 14, 151-218. The aminic catalysts may be used in concentrations, based on the amount of end product, of 200 ppm to 10 000 ppm, wherein the concentration range from 200 ppm to 5000 ppm is preferred.

In a further, less preferred embodiment of the process according to the invention, the basic catalysts employed are carboxylic acid salts of alkali metals or alkaline earth metals. The underlying carboxylic acids may be monobasic or polybasic. Examples include salts of acetic, propionic and adipic acid. Such alkali metal or alkaline earth metal carboxylates are typically employed in amounts of 0.04% to 2% by mass, based on the amount of end product.

According to the invention suitable solvents (5)/suspending agents include inert organic solvents such as for example toluene or else water. Especially the presence of water in step (ii) of the process according to the invention can promote the reaction of the at least one H-functional starter compound having a melting point>50° C. with alkylene oxides. In order to obtain alkylene oxide addition products that are of high quality, i.e. low in byproducts, it is recommended to remove water from the reaction mixture after reaching a certain degree of alkoxylation, see for example German laid-open specification DE 1443022 in this respect. The separation of the water in step (iii) of the process according to the invention should additionally be carried out before the addition of the fatty acid ester in step (iv) to avoid undesired hydrolysis reactions.

In one embodiment of the process according to the invention, in step i) the system (i) comprises a solvent (5), wherein the solvent (5) contains water and preferably the solvent (5) is water.

In a preferred embodiment of the process according to the invention, in step i) the system (i) comprises the H-functional starter compound (1), the basic catalyst (4) and the solvent (5), wherein the solvent (5) contains water and preferably the solvent (5) is water.

Steps (i), (ii), (iii), (iv) and (v) of the process according to the invention are specifically performed as described below:

In step (i) of the process according to the invention a system (i) comprising the starter compound (1) and optionally the basic catalyst (4) optionally in a solvent (5) is provided in a reaction vessel.

According to the invention the system (i) in step (i) also comprises the starter compound (1), the starter compound (1) and the basic catalyst (4) or the starter compound (1) and the solvent (5) insofar as only the starter compound (1), the starter compound (1) and the basic catalyst (4) or the starter compound (1) and the solvent (5) are employed in step (i).

It is preferable when the basic catalyst (4) and the solvent (5) are used in step (i) so that a system (i) comprising the starter compound (1) and the basic catalyst (4) with a solvent (5) is provided in a reaction vessel.

The system (i) is prepared by stirring or recirculation via a dispersing unit with inertization of the reaction vessel (for example by repeated pressurization with nitrogen in each case followed by decompression to atmospheric pressure and optionally evacuation to pressures<1 bar). Stirring/recirculation may be effected at elevated temperature, for example at 50° C. to 150° C. and under an inert gas atmosphere (for example nitrogen), to facilitate mixing/dispersing of the components. It is generally unnecessary to adhere to a particular minimum stirring or minimum recirculation time.

In step (ii) of the process according to the invention n(3−1) mol of a first sub-amount of the alkylene oxide (3) are added to the system (i) over a period t₁ to form an intermediate (ii).

The addition of the first sub-amount of the alkylene oxide (3) to the system (i) is carried out at temperatures of 70-170° C., preferably 100-150° C. (70-150° C. when amine catalysts are used), over a period t₁ of preferably 120 min to 12 h, particularly preferably from 150 min to 11 h.

The alkylene oxide (3) is continuously supplied to the reactor in conventional fashion in such a way that the safety-related pressure limits of the employed reactor system are not exceeded. Such reactions are typically carried out in the pressure range from 10 mbar to 10 bar. Especially in the case of metered addition of ethylene oxide-containing alkylene oxide mixtures or pure ethylene oxide, it should be ensured that a sufficient partial inert gas pressure is maintained within the reactor during the startup and metering phase. This can be established, for example, by means of noble gases or nitrogen. The alkylene oxides (3) may be supplied to the reactor in different ways: One option is metered addition into the gas phase or directly into the liquid phase, for example via an immersed tube or a distributor ring close to the reactor base in a zone with good mixing. In the case of metered addition into the liquid phase, the metered addition units should be designed so as to be self-emptying, for example by situating the metered addition holes on the underside of the distributor ring. Backflow of reaction medium into the alkylene oxide-conducting conduits and metered addition units or into the alkylene oxide reservoir vessels can be advantageously prevented by apparatus measures, for example through installation of non-return valves.

The reaction of the first sub-amount of the alkylene oxide (3) with the system (i) is preferably carried out at a temperature of 70° C. to 170° C., particularly preferably at a temperature of 100° C. to 150° C. The temperature may be varied within the described limits during the alkylene oxide metered addition phase: To achieve an optimal balance between high alkylene oxide conversion and low byproduct formation when using sensitive starter compounds (for example sucrose), alkoxylation may initially be performed at low reaction temperatures (for example at 70° C. to 110° C.), a transition to higher reaction temperatures (for example to 110° C. to 130° C.) being made only upon sufficient starter conversion (i.e. once at least 50% by mass of the employed starter compounds (1) have reacted with alkylene oxide). The end of the metered addition phase for the first sub-amount of the alkylene oxide (3) is typically followed by a post-reaction phase in which the remaining alkylene oxide reacts. Post-reactions may optionally be performed at higher temperatures (i.e. after raising the temperature to 100° C. to 170° C., preferably 100° C. to 150° C.). The end of such a post-reaction phase is reached when no further pressure drop or only a very slow remaining pressure drop is detectable in the reaction vessel at approximately constant temperature.

The temperature of the exothermic alkylene oxide addition reaction is kept at the desired level by cooling. According to the prior art relating to the design of polymerization reactors for exothermic reactions (for example Ullmann's Encyclopedia of Industrial Chemistry, volume B4, page 167ff., 5th edition, 1992), such cooling is generally effected via the reactor wall (e.g. double jacket, half-coil pipe) and by means of further heat exchange surfaces disposed internally in the reactor and/or externally in the pumped circulation circuit, for example in cooling coils, cooling cartridges, or plate, shell-and-tube or mixer heat exchangers. These should advantageously be configured such that effective cooling is possible even at commencement of the metering phase, i.e. at a low fill level and/or in the presence of possibly heterogeneous reactor contents (for example in the case of solid dispersions or suspensions/emulsions).

In one embodiment of the process according to the invention, in step (iii) any solvent (5) present is removed from the intermediate (ii) to form an intermediate (iii). It is preferable to perform step (iii) in the process according to the invention.

In order to rule out the presence of the solvent (5), preferably water being the solvent (5), with certainty, the removal thereof from the intermediate (ii) before addition of the fatty acid ester (2) may be assisted through the use of vacuum at temperatures of 80-150° C. (40-130° C. when using amine catalysts), optionally through additional stripping with inert gas. If amines are used as catalysts these may optionally also be added only after such a dewatering step. Removal of the solvent (5), preferably water, affords intermediate (iii) in step (iii).

In step (iv) of the process according to the invention the fatty acid ester (2) is added to the intermediate (ii) or to the intermediate (iii) to form the intermediate (iv), wherein n(2) mol of fatty acid ester groups are supplied to the intermediate (ii) or the intermediate (iii).

In a preferred embodiment of the process according to the invention, in step (iv) the fatty acid ester (2) is added to the intermediate (iii) to form the intermediate (iv), wherein n(2) mol of fatty acid ester groups are supplied to the intermediate (iii).

The number of moles n(2) of the fatty acid ester groups supplied to the intermediate (ii)/optionally to the intermediate (iii) are easily calculable by a person skilled in the art when the structure and molar mass of the fatty acid ester are known. For example, 2000 g of the triglyceride soybean oil (molar mass: 880 Da) contain 6.8 mol of ester groups. Alternatively, if the structure of the fatty acid ester is unknown the number of ester groups present may also be determined via the saponification number according to DIN 53401.

The intermediate (iv) is prepared by stirring or recirculation via a dispersing unit with inertization of the reaction vessel (for example by repeated pressurization with nitrogen in each case followed by decompression to atmospheric pressure and optionally evacuation to pressures<1 bar).

Stirring/recirculation may be effected at elevated temperature, for example at 50° C. to 150° C. and under an inert gas atmosphere (for example nitrogen), to facilitate mixing/dispersing of the components. It is generally unnecessary to adhere to a particular minimum stirring or minimum recirculation time.

In step (v) of the process according to the invention n(3−2) mol of a second sub-amount of the alkylene oxide (3) are added to the intermediate (iv) over a period t₂ to form the polyoxyalkylene polyester polyol according to the invention.

The recommended reaction conditions and apparatus parameters correspond to those already described for step (ii). Step (v) generally also ends with a post-reaction step which may likewise be performed at relatively high temperatures (i.e. after raising the temperature to 100° C. to 170° C., preferably 100° C. to 150° C.). The end of such a post-reaction phase is reached when no further pressure drop or only a very slow remaining pressure drop is detectable in the reaction vessel at approximately constant temperature. Such a criterion for the end of the post-reaction time is determinable on an individual basis. For example it is customary to achieve a pressure drop rate of 20 mbar per hour at pressures in the range of about 2 bar or higher. If such a pressure drop rate specified for the post-reaction duration is achieved or undershot it is recommended to reduce the temperature to values below 100° C., preferably to values below 80° C., to inhibit the formation of undesired secondary components.

The crude polyoxyalkylene polyether ester polyol resulting from step (v) may optionally be subjected to work-up steps to remove or to deactivate any catalyst traces. In the case of alkylene oxide addition reactions catalyzed with amines, such aftertreatment steps are generally not required. The optional removal of the catalyst from the crude polyoxyalkylene polyether ester polyol resulting from step (v) may be carried out in different ways: For example, the basic catalyst, for example KOH, may be neutralized with dilute mineral acids such as sulphuric acid or phosphoric acid. If neutralization is effected using strong diluted mineral acids (pKa of 1st dissociation stage<2.8) the neutralization should be carried out at relatively low temperatures, for example at 20° C. to 80° C., preferably at 20-60° C., and the amount of acid required for neutralization should be supplied to the alkaline alkylene oxide addition product as quickly as possible to ensure that the basic reaction products are hydrolyzed and neutralized at the same time. It is therefore advisable to eschew a separate hydrolysis step before addition of the neutralization acid. Such a procedure ensures that side reactions at the ester bonds of the polyoxyalkylene polyether ester polyols are avoided to the greatest possible extent. The salts formed in the course of neutralization are removed, for example by filtration. The polyether polyol preparation processes described in EP-A 2028211 and WO-A 2009106244 are exceptions. Alternatively, the neutralization may be effected with hydroxycarboxylic acids (for example lactic acid, as described in WO-A 9820061 and US-A 2004167316). Carboxylic acids such as for example formic acid (cf. U.S. Pat. No. 4,521,548) or else adipic acid are likewise suitable for neutralization. In order to achieve a proton concentration in the polyoxyalkylene polyether ester polyol that is sufficiently high for the intended application, (hydroxy)carboxylic acids are often used in an amount that is in marked excess relative to the amount of basic catalyst to be neutralized. The metal carboxylates formed after neutralization with some carboxylic acids (for example hydroxycarboxylic acids or formic acid) are soluble in the polyoxyalkylene polyether ester polyols to give a clear solution and removal of the salts may therefore be dispensed with here. The neutralization may also be carried out for example by addition of cyclic dicarboxylic anhydrides, such as phthalic anhydride, maleic anhydride, tetrahydrophthalic anhydride or succinic anhydride, to obtain salts which are likewise soluble in the polyoxyalkylene polyether ester polyols according to the invention. Also possible is the use of ring-opening products of cyclic carboxylic anhydrides with polyols, i.e. of dicarboxylic acid half-esters, as neutralizing agents. It should finally be noted that the incompletely alkoxylated oxo acids of phosphorus are likewise suitable as neutralization acids. It is likewise possible to remove the catalyst by using acidic cation exchangers as described for example in DE-A 100 24 313. The catalysts may moreover be removed using adsorbents such as for example phyllosilicates (bentonite, attapulgite), diatomaceous earth or else synthetic magnesium silicates (such as AMBOSOL® or BriteSorb®). Such purification processes are described in RO 118433, U.S. Pat. No. 4,507,475, EP-A 0693513 and EP-A 1751213. Phase separation processes in principle represent a further possibility for separating catalyst residues, but the water solubilities of the polyoxyalkylene polyether ester polyols or of components present therein are generally too high for phase separation processes to be carried out effectively. Phase separation processes are described, for example, in WO-A 0114456, JP-A 6-157743, WO-A 9620972 and U.S. Pat. No. 3,823,145.

The polyoxyalkylene polyether ester polyols according to the invention may be admixed with antioxidants (for example based on phenol derivatives and/or based on aromatic amines). If an alkali metal hydroxide is used to catalyze the alkylene oxide addition onto the employed starter compounds it is advisable to add such antioxidants only after neutralization/removal of these catalyst traces since this makes it possible to obtain less strongly discolored polyoxyalkylene polyether ester polyols.

In a preferred embodiment of the process according to the invention, the mixing power input in steps (i) to (v) is between 0.8 and 5 W/l, particularly preferably between 0.8 and 3 W/l, based on the liquid volume after termination of step (v), i.e. after completed metered addition of all reactants.

Good mixing of the reactor contents in all reaction and/or mixing phases should generally be ensured through configuration and use of commercially available stirrer units, wherein suitable stirrer units here especially include stirrers arranged over one or more levels or stirrer types which act over the full fill height (see, for example, Handbuch Apparate; Vulkan-Verlag Essen, 1st ed. (1990), pp. 188-208). Of particular technical relevance here is a mixing power introduced on average over the entire reactor contents which based on the liquid volume after termination of step (v), i.e. based on the fill level at the end of the metered addition of all reactants, is in the range from 0.8 to 5 W/l, preferably in the range from 0.8 to 3 W/l, with correspondingly higher local power inputs in the region of the stirrer units themselves and possibly in the case of relatively low fill levels. In order to achieve an optimal stirring effect, combinations of baffles (e.g. flat or tubular flow baffles) and cooling coils (or cooling candles) may be arranged within the reactor according to the general prior art and may also extend across the vessel base. The stirring power of the mixing apparatus may also be varied as a function of the fill level during the metered addition phase to ensure a particularly high energy input in critical reaction phases. For example, it may be advantageous to particularly vigorously mix solids-containing dispersions which may be present at the start of the reaction, for example, in the case of use of sucrose. Moreover, particularly when solid H-functional starter compounds are used, it should be ensured through the selection of the stirrer unit that sufficient dispersion of the solids in the reaction mixture is assured. It is preferable here to employ stirrer stages with close base clearance and particularly stirrer units suitable for suspension. In addition, the stirrer geometry should contribute to reducing foaming of reaction products. Foaming of reaction mixtures can be observed, for example, after the end of the metered addition and post-reaction phases when residual alkylene oxides are additionally removed under vacuum at absolute pressures in the range from 1 to 500 mbar. For such cases, stirrer units that achieve continuous mixing of the liquid surface have been found to be suitable. As required, the stirrer shaft has a base bearing and optionally further support bearings within the vessel. The stirrer shaft can be driven from the top or bottom (with a central or eccentric arrangement of the shaft).

It is alternatively also possible to achieve the necessary mixing and the necessary mixing power input exclusively via a pumped circulation circuit passing through a heat exchanger or to operate this pumped circulation circuit as a further mixing component in addition to the stirrer unit, thus effecting pumped circulation of the reactor contents as required (typically 1 to 50 times per hour). The specific mixing power introduced by means of pumped circulation, for example through an external heat exchanger or, in the case of recycling into the reactor, through a nozzle or injector, likewise amounts to values averaging from 0.8 to 5 W/l, preferably 0.8 to 3 W/l, wherein this is based on the liquid volume present in the reactor and the pumped circulation circuit after completed metered addition of all reactants, i.e. the fill level after termination of step (v).

It is recommended not only to perform the preparation of the polyoxyalkylene polyester polyols according to the invention in the absence of oxygen but also to handle and to store the corresponding finished products, i.e. finished, optionally salt-free and antioxidant-stabilized polyoxyalkylene polyester polyols according to the invention in the absence of oxygen. Inert gases suitable for this purpose are, for example, noble gases or nitrogen or carbon dioxide, noble gases or nitrogen being particularly suitable. The prevention of ingress of oxygen very substantially prevents further product discoloration and this is especially true at elevated temperatures which are generally utilized to facilitate handling of the finished products by lowering product viscosity. An inert gas atmosphere moreover also results in the formation of markedly fewer peroxide groups which, through cleavage of polyether bonds present, contribute to the formation of further low molecular weight oxidative degradation products, for example acetaldehyde, methanol, formic acid, formic esters, acetone and formaldehyde. It is thus possible to minimize reductions in quality, lower the content of volatile organic compounds and prevent odour nuisance and impairment to health during the storage of the finished products.

The invention further provides polyoxyalkylene polyester polyols obtainable by the process according to the invention.

According to the invention the resulting polyoxyalkylene polyester polyol has a calculated OH number of 320 mg(KOH)/g to 530 mg(KOH)/g, preferably from 350 mg(KOH)/g to 500 mg(KOH)/g.

The number-average OH functionality Fₙ of the polyoxyalkylene polyester polyols obtainable by the process according to the invention is preferably at least 2.4, particularly preferably 2.4 to 4.8, wherein the number-average functionality Fₙ is calculated according to the following formula (1),

$${F}_{n} = \frac{{Σ}_{i} {n}_{i} \times {F}_{i} + {Σ}_{j} {n}_{j} \times {F}_{j} + {Σ}_{f} {n}_{f} \times {F}_{f}}{{Σ}_{i} {n}_{i} + {Σ}_{j} {n}_{j} + {Σ}_{f} {n}_{f}} \qquad ( 1 )$$

wherein Fᵢ is the H-functionality of the hydroxy-functional starter compound i and nᵢ is the employed number of moles of hydroxy-functional starter compound i, nⱼ is the employed number of moles of amine-functional starter compound j and Fⱼ is the number of aminic protons introduced per molecule of the aminic starter compound and n_{f} is the employed number of moles of fatty acid ester f and F_{f} is the hydroxy functionality of the fatty acid ester f. For example, soybean oil bears no fatty acid residues having OH groups, and so f_{soybean oil}=0. Castor oil, on the other hand, has an average OH functionality of 2.7, and so f_{castor oil}=2.7.

In one embodiment, the resulting polyoxyalkylene polyester polyol has a turbidity number (turbidity value) of ≤30 NTUs, preferably of ≤20 NTUs, determined according to method 180.1 of the United States Environmental Protection Agency USEPA. The unit of measurement is NTU (nephelometric turbidity units).

The present invention further provides a process for preparing polyurethanes by reaction of the polyoxyalkylene polyester polyol prepared according to the invention with a polyisocyanate. The polyoxyalkylene polyester polyols may be used as starting components for the preparation of solid or foamed polyurethane materials, for example coatings or rigid foams for insulation purposes. Such polyurethane materials may also contain isocyanurate, allophanate and biuret structural units.

For preparation of the foamed or solid polyurethane materials the polyoxyalkylene polyester polyols according to the invention are optionally mixed with further isocyanate-reactive components and reacted with organic polyisocyanates, optionally in the presence of blowing agents, in the presence of catalysts and optionally in the presence of other additives such as cell stabilizers for example.

As further isocyanate-reactive components the polyoxyalkylene polyester polyols according to the invention may optionally be admixed with polyether polyols, polyester polyols, polycarbonate polyols, polyether carbonate polyols, polyester carbonate polyols, polyether ester carbonate polyols and/or low molecular weight chain extenders and/or crosslinkers having OH numbers or NH numbers of 6 to 1870 mg KOH/g.

Polyether polyols suitable therefor are obtainable for example by anionic polymerization of alkylene oxides in the presence of alkali metal hydroxides or alkali metal alkoxides as catalysts and with addition of at least one starter molecule containing 2 to 8 Zerewitinoff-active hydrogen atoms or by cationic polymerization of alkylene oxides in the presence of Lewis acids such as antimony pentachloride, boron trifluoride etherate or tris(pentafluorophenyl)borane. It will be appreciated that suitable catalysts also include those of the double metal cyanide complex type, so-called DMC catalysts, as described for example in U.S. Pat. Nos. 3,404,109, 3,829,505, 3,941,849, 5,158,922, 5,470,813, EP-A 700 949, EP-A 743 093, EP-A 761 708, WO 97/40086, WO 98/16310 and WO 00/47649. Suitable alkylene oxides and a number of suitable starter compounds have already been described in the preceding paragraphs. Also worthy of mention are tetrahydrofuran as the cyclic ether polymerizable as Lewis acid and water as the starter molecule. The polyether polyols, preferably polyoxypropylene-polyoxyethylene polyols, preferably have number-average molar masses of 200 to 8000 Da. Suitable polyether polyols further include polymer-modified polyether polyols, preferably graft polyether polyols, in particular those based on styrene and/or acrylonitrile, which are advantageously prepared in the abovementioned polyether polyols by in situ polymerization of acrylonitrile, styrene or preferably mixtures of styrene and acrylonitrile, for example in a mass ratio of 90:10 to 10:90, preferably 70:30 to 30:70, and also polyether polyol dispersions which contain inorganic fillers, polyureas, polyhydrazides, polyurethanes comprising bound tertiary amino groups and/or melamine as the disperse phase typically in an amount of 1% to 50% by mass, preferably 2% to 25% by mass.

Suitable polyester polyols may be prepared for example from organic dicarboxylic acids having 2 to 12 carbon atoms and polyhydric alcohols, preferably diols, having 2 to 12 carbon atoms, preferably 2 to 6 carbon atoms. Contemplated dicarboxylic acids include for example: Succinic acid, glutaric acid, adipic acid, suberic acid, azelaic acid, sebacic acid, decanedicarboxylic acid, dodecanedicarboxylic acid, maleic acid, fumaric acid, phthalic acid, isophthalic acid and terephthalic acid. The dicarboxylic acids may be used either individually or in admixture with one another. Instead of the free dicarboxylic acids it is also possible to employ the corresponding dicarboxylic acid derivatives, for example dicarboxylic mono- and/or diesters of alcohols having 1 to 4 carbon atoms or dicarboxylic anhydrides. It is preferable to employ dicarboxylic acid mixtures of succinic, glutaric and adipic acid in quantity ratios of for example 20 to 35/40 to 60/20 to 36 parts by mass and in particular adipic acid. Examples of dihydric and polyhydric alcohols are ethanediol, diethylene glycol, 1,2- and 1,3-propanediol, dipropylene glycol, methyl-1,3-propanediol, 1,4-butanediol, 1,5-pentanediol, 3-methyl-1,5-pentanediol, 1,6-hexanediol, neopentyl glycol, 1,10-decanediol, 1,12-dodecanediol, glycerol, trimethylolpropane and pentaerythritol. Preference is given to using 1,2-ethanediol, diethylene glycol, 1,4-butanediol, 1,6-hexanediol, glycerol, trimethylolpropane or mixtures of at least two of the recited polyhydric alcohols, in particular mixtures of ethanediol, 1,4-butanediol and 1,6-hexanediol, glycerol and/or trimethylolpropane. Also employable are polyester polyols made from lactones, for example c-caprolactone, or hydroxycarboxylic acids, for example hydroxycaproic acid and hydroxyacetic acid.

To prepare the polyester polyols the organic, aromatic or aliphatic polycarboxylic acids and/or polycarboxylic acid derivatives and polyhydric alcohols may be subjected to polycondensation up to the desired acid and OH numbers in the absence of catalyst or in the presence of transesterification catalysts, advantageously in an atmosphere of inert gases, for example nitrogen, helium or argon, and also in the melt at temperatures of 150° C. to 300° C., preferably 180° C. to 230° C., optionally under reduced pressure. The acid number of such polyester polyols is advantageously less than 10 mg KOH/g, preferably less than 2.5 mg KOH/g.

In a preferred production process the esterification mixture is subjected to polycondensation at the abovementioned temperatures up to an acid number of 80 to 30 mg KOH/g, preferably 40 to 30 mg KOH/g, under standard pressure and subsequently at a pressure of less than 500 mbar, preferably 1 to 150 mbar. Contemplated esterification catalysts are for example iron, cadmium, cobalt, lead, zinc, antimony, magnesium, titanium and tin catalysts in the form of metals, metal oxides or metal salts. However, the polycondensation of aromatic or aliphatic carboxylic acids with polyhydric alcohols may also be performed in the liquid phase in the presence of diluents and/or entrainers, for example benzene, toluene, xylene or chlorobenzene, for azeotropic distillative removal of the water of condensation.

The ratio of dicarboxylic acid (derivative) and polyhydric alcohol to be chosen to obtain a desired OH number, functionality and viscosity, and the alcohol functionality to be chosen, may be simply determined by those skilled in the art.

Suitable polycarbonate polyols are those of the type known per se which may be prepared for example by reaction of diols, such as 1,2-propanediol, 1,4-butanediol, 1,6-hexanediol, diethylene glycol, triethylene glycol, tetraethylene glycol, oligo-tetramethylene glycol and/or oligo-hexamethylene glycol with diarylcarbonates and/or dialkyl carbonates, for example diphenyl carbonate, dimethyl carbonate and α-ω-bischloroformate or phosgene. The likewise suitable polyether carbonate polyols are obtained by copolymerization of cyclic epoxides and carbon dioxide; such copolymerizations are preferably performed under high pressure and catalyzed by double metal cyanide (DMC) compounds.

Low molecular weight bifunctional chain extenders and/or low molecular weight, preferably tri- or tetrafunctional, crosslinking agents may be admixed with the polyoxyalkylene polyester polyols for use according to the invention to modify the mechanical properties, in particular the hardness, of the PUR materials. Suitable chain extenders such as alkanediols, dialkylene glycols and polyalkylene polyols and crosslinking agents, for example tri- or tetravalent alcohols and oligomeric polyalkylene polyols having a functionality of 3 to 4, typically have molar masses<800, preferably of 18 to 400, and in particular of 60 to 300 Da. Preferably employed chain extenders are alkanediols having 2 to 12 carbon atoms, for example ethanediol, 1,3-propanediol, 1,5-pentanediol, 1,6-hexanediol, 1,7-heptanediol, 1,8-octanediol, 1,9-nonanediol, 1,10-decanediol and in particular 1,4-butanediol and dialkylene glycols having 4 to 8 carbon atoms, for example diethylene glycol and dipropylene glycol and also polyoxyalkylene glycols. Also suitable are branched-chain and/or unsaturated alkanediols typically having not more than 12 carbon atoms, for example, 1,2-propanediol, 2-methyl-1,3-propanediol, 3-methyl-1,5-pentanediol, 2,2-dimethyl 1,3-propanediol, 2-butyl-2-ethyl-1,3-propanediol, 2-butene-1,4-diol and 2-butyne-1,4-diol, diesters of terephthalic acid with glycols having 2 to 4 carbon atoms, for example bis-ethylene glycol terephthalate or bis-1,4-butylene glycol terephthalate, and hydroxyalkylene ethers of hydroquinone or resorcinol, for example 1,4-di-(β-hydroxyethyl)hydroquinone or 1,3-(β-hydroxyethyl)resorcinol. It is also possible to use alkanolamines having 2 to 12 carbon atoms such as ethanolamine, 2-aminopropanol and 3-amino-2,2-dimethylpropanol, N-alkyldialkanolamines, for example N-methyl- and N-ethyl-diethanolamines, (cyclo)aliphatic diamines having 2 to 15 carbon atoms, such as 1,2-ethylenediamine, 1,3-propylenediamine, 1,4-butylenediamine and 1,6-hexamethylenediamine, isophoronediamine, 1,4-cyclohexamethylenediamine and 4,4′-diaminodicyclohexylmethane, N-alkyl-, N,N′-dialkyl-substituted and aromatic diamines which may also be substituted at the aromatic radical by alkyl groups having 1 to 20, preferably 1 to 4, carbon atoms in the N-alkyl radical, such as N,N′-diethyl-, N,N′-di-sec-pentyl-, N,N′-di-sec-hexyl-, N,N′-di-sec-decyl- and N,N′-dicyclohexyl-p- or -m-phenylenediamine, N,N′-dimethyl-, N,N′-diethyl-, N,N′-diisopropyl-, N,N′-di-sec-butyl-, N,N′-dicyclohexyl-4,4′-diamino-diphenylmethane, N,N′-di-sec-butylbenzidine, methylenebis(4-amino-3-benzoic acid methyl ester), 2,4-chloro-4,4′-diaminodiphenylmethane and 2,4- and 2,6-tolylenediamine. Suitable crosslinkers are for example glycerol, trimethylolpropane or pentaerythritol.

Also usable are mixtures of different chain extenders and crosslinkers with one another and mixtures of chain extenders and crosslinkers.

Suitable organic polyisocyanates are cycloaliphatic, araliphatic, aromatic and heterocyclic polyisocyanates, such as are described, for example, by W. Siefken in Justus Liebigs Annalen der Chemie, 562, pages 75 to 136, for example those of the formula Q(NCO)ₙ in which n=2-4, preferably 2, and Q is an aliphatic hydrocarbon radical having 2-18, preferably 5-10, carbon atoms, a cycloaliphatic hydrocarbon radical having 4-15, preferably 5-10, carbon atoms, an aromatic hydrocarbon radical having 6-15, preferably 6-13, carbon atoms or an araliphatic hydrocarbon radical having 8-15, preferably 8-13, carbon atoms. Suitable compounds include for example ethylene diisocyanate, 1,4-tetramethylene diisocyanate, 1,5-pentamethylene diisocyanate, 1,6-hexamethylene diisocyanate (HDI), 1,12-dodecane diisocyanate, cyclobutane 1,3-diisocyanate, cyclohexane-1,3- and -1,4-diisocyanate and any desired mixtures of these isomers, 1-isocyanato-3,3,5-trimethyl-5-isocyanatomethylcyclohexane (DE-B 1 202 785, U.S. Pat. No. 3,401,190), 2,4- and 2,6-hexahydrotolylene diisocyanate and any desired mixtures of these isomers, hexahydro-1,3- and -1,4-phenylene diisocyanate, perhydro-2,4′- and -4,4′-diphenylmethane diisocyanate, 1,3- and 1,4-phenylene diisocyanate (DE-A 196 27 907), 1,4-durene diisocyanate (DDI), 4,4′-stilbene diisocyanate (DE-A 196 28 145), 3,3′-dimethyl-4,4′-biphenylene diisocyanate (DIBDI) (DE-A 195 09 819), 2,4- and 2,6-tolylene diisocyanate (TDJ) and any desired mixtures of these isomers, diphenylmethane 2,4′-diisocyanate and/or diphenylmethane 4,4′-diisocyanate (MDI) or naphthylene 1,5-diisocyanate (NDI).

Also suitable according to the invention are for example: triphenylmethane 4,4′,4″-triisocyanate, polyphenyl-polymethylene polyisocyanates, as obtained by aniline-formaldehyde condensation and subsequent phosgenation and described for example in GB-A 874 430 and GB-A 848 671, m- and p-isocyanatophenylsulfonyl isocyanates according to U.S. Pat. No. 3,454,606, perchlorinated aryl polyisocyanates, as described in U.S. Pat. No. 3,277,138, polyisocyanates containing carbodiimide groups, as described in U.S. Pat. No. 3,152,162 and in DE-A 25 04 400, 25 37 685 and 25 52 350, norbornane diisocyanates according to U.S. Pat. No. 3,492,301, polyisocyanates containing allophanate groups, as described in GB-A 994 890, BE-B 761 626 and NL-A 7 102 524, polyisocyanates containing isocyanurate groups, as described in U.S. Pat. No. 3,001,9731, in DE-C 10 22 789, 12 22 067 and 1 027 394 and in DE-A 1 929 034 and 2 004 048, polyisocyanates containing urethane groups, as described for example in BE-B 752 261 or in U.S. Pat. Nos. 3,394,164 and 3,644,457, polyisocyanates containing acylated urea groups according to DE-C 1 230 778, polyisocyanates containing biuret groups, as described in U.S. Pat. Nos. 3,124,605, 3,201,372 and 3,124,605 and in GB-B 889 050, polyisocyanates prepared by telomerization reactions, as described in U.S. Pat. No. 3,654,106, polyisocyanates containing ester groups, as recited in GB-B 965 474 and 1 072 956, in U.S. Pat. No. 3,567,763 and in DE-C 12 31 688, reaction products of the abovementioned isocyanates with acetals according to DE-C 1 072 385, and polyisocyanates containing polymeric fatty acid esters according to U.S. Pat. No. 3,455,883.

It is also possible to use the distillation residues containing isocyanate groups generated during industrial isocyanate preparation, optionally dissolved in one or more of the abovementioned polyisocyanates. Any desired mixtures of the abovementioned polyisocyanates may also be used.

It is preferable to employ the industrially readily available polyisocyanates, for example 2,4- and 2,6-tolylene diisocyanate and any desired mixtures of these isomers (“TDI”); polyphenyl polymethylene polyisocyanates as prepared by aniline-formaldehyde condensation and subsequent phosgenation (“crude MDI”), and polyisocyanates comprising carbodiimide groups, urethane groups, allophanate groups, isocyanurate groups, urea groups or biuret groups (“modified polyisocyanates”), especially modified polyisocyanates deriving from 2,4- and/or 2,6-tolylene diisocyanate or from 4,4′- and/or 2,4′-diphenylmethane diisocyanate. Naphthylene 1,5-diisocyanate and mixtures of the recited polyisocyanates are also well suitable.

It is also possible to use prepolymers containing isocyanate groups obtainable by reacting a portion or the total amount of the polyoxyalkylene polyester polyols for use according to the invention and/or a portion or the total amount of the abovedescribed isocyanate-reactive components for optional admixture with the polyoxyalkylene polyester polyols for use according to the invention with at least one aromatic di- or polyisocyanate from the group TDI, MDI, DIBDI, NDI, DDI, preferably with 4,4′-MDI and/or 2,4-TDI and/or 1,5-NDI, to afford a polyaddition product comprising urethane groups, preferably urethane groups and isocyanate groups. Such polyaddition products have NCO contents of 20.0% to 40.0% by mass. In a preferably employed embodiment the prepolymers containing isocyanate groups are prepared by reaction of exclusively higher molecular weight polyhydroxyl compounds, i.e. the polyoxyalkylene polyester polyols for use according to the invention, and/or polyether polyols, polyester polyols or polycarbonate polyols with the polyisocyanates, preferably 4,4′-MDI and/or 2,4-TDI.

The prepolymers containing isocyanate groups may be prepared in the presence of catalysts. However, it is also possible to prepare the prepolymers containing isocyanate groups in the absence of catalysts and to add these to the reaction mixture for preparing the PUR materials.

The blowing agent employed for optional use for the purpose of foam preparation may be water which reacts in situ with the organic polyisocyanates or with the prepolymers comprising isocyanate groups to form carbon dioxide and amino groups, the latter in turn undergoing further reaction with further isocyanate groups to afford urea groups and thus acting as chain extenders. If water is added to the polyurethane formulation to adjust the desired density this is typically employed in amounts of 0.001% to 6.0% by mass based on the mass of the employed polyoxyalkylene polyester polyols according to the invention, optionally further isocyanate-reactive components, the catalysts and further additives.

Blowing agents that may be employed as physical blowing agents instead of water or preferably in combination with water also include gases or highly volatile inorganic or organic substances which evaporate under the influence of the exothermic polyaddition reaction and advantageously have a boiling point at standard pressure in the range from −40° C. to 120° C., preferably from 10° C. to 90° C. Organic blowing agents that may be employed include for example acetone, ethyl acetate, methyl acetate, halogen-substituted alkanes such as methylene chloride, chloroform, ethylidene chloride, vinylidene chloride, monofluorotrichloromethane, chlorodifluoromethane, dichlorodifluoromethane, HFCs such as R 134a, R 245fa and R 365mfc, partially fluorinated olefins (“hydrofluoroolefins”, HFOs), and also unsubstituted alkanes such as butane, n-pentane, isopentane, cyclopentane, hexane, heptane or diethyl ether. Suitable inorganic blowing agents include for example air, CO₂ or N₂O. A blowing effect can also be achieved by addition of compounds which at temperatures above room temperature decompose with elimination of gases, for example nitrogen and/or carbon dioxide, such as azo compounds, for example azodicarbonamide or azoisobutyronitrile, or salts such as ammonium bicarbonate, ammonium carbamate or ammonium salts of organic carboxylic acids, for example the monoammonium salts of malonic acid, boric acid, formic acid or acetic acid. Further examples of blowing agents, particulars concerning the use of blowing agents and criteria for blowing agent selection are described in R. Vieweg, A. Höchtlen (eds.): “Kunststoff-Handbuch”, Volume VII, Carl-Hanser-Verlag, Munich 1966, pp. 108f, 453ff and 507-510 as well as in D. Randall, S. Lee (eds.): “The Polyurethanes Book”, John Wiley & Sons, Ltd., London 2002, pp. 127-136, 232-233 and 261.

The amount of solid blowing agents, low-boiling liquids or gases to advantageously be employed, each of which may be employed individually or in the form of mixtures, for example as liquid or gas mixtures or as gas-liquid mixtures depends on the desired PUR material density and the amount of water employed. The required amounts may be easily determined experimentally.

In the absence of moisture and physically or chemically acting blowing agents, compact PUR materials may of course also be produced.

Amine catalysts that are familiar to those skilled in the art and have proven advantageous for polyurethane material preparation are for example tertiary amines such as triethylamine, tributylamine, N-methyl-morpholine, N-ethyl-morpholine, N,N,N′,N′-tetramethylethylenediamine, pentamethyldiethylenetriamine and higher homologs (DE-OS 26 24 527 and 26 24 528), 1,4-diaza-bicyclo-(2,2,2)-octane, N-methyl-N′-dimethylaminoethylpiperazine, bis(dimethylaminoalkyl)-piperazine (DE-A 26 36 787), N,N-dimethylbenzylamine, N,N-dimethylcyclohexylamine, N,N-diethylbenzylamine, bis(N,N-diethylaminoethyl)adipate, N,N,N′,N′-tetramethyl-1,3-butane-diamine, N,N-dimethyl-β-phenylethylamine, bis(dimethylaminopropyl)urea, 1,2-dimethylimidazole, 2-methylimidazole, monocyclic and bicyclic amidines (DE-A 17 20 633), bis(dialkylamino)alkyl ethers (U.S. Pat. No. 3,330,782, DE-B 10 30 558, DE-A 18 04 361 and 26 18 280) and tertiary amines comprising amide groups (preferably formamide groups) according to DE-A 25 23 633 and 27 32 292. Suitable catalysts further include Mannich bases known per se and composed of secondary amines, such as dimethylamine, and aldehydes, preferably formaldehyde, or ketones such as acetone, methyl ethyl ketone or cyclohexanone and phenols, such as phenol or alkyl-substituted phenols. Tertiary amines comprising isocyanate-reactive hydrogen atoms as catalysts include for example triethanolamine, triisopropanolamine, N-methyl-diethanolamine, N-ethyldiethanolamine, N,N-dimethylethanolamine, reaction products thereof with alkylene oxides such as propylene oxide and/or ethylene oxide and secondary-tertiary amines according to DE-A 27 32 292. Catalysts that may be employed further include silaamines having carbon-silicon bonds as described in U.S. Pat. No. 3,620,984, for example 2,2,4-trimethyl-2-silamorpholine and 1,3-diethylaminomethyltetramethyldisiloxane. Nitrogen-containing bases such as tetraalkylammonium hydroxides and also hexahydrotriazines are also contemplated. The reaction between NCO groups and Zerewitinoff-active hydrogen atoms is also greatly accelerated by lactams and azalactams by initially forming an adduct between the lactam and the compound comprising acidic hydrogen.

When the catalysis of the polyurethane reaction employs amines as catalysts it must naturally be taken into account that polyoxyalkylene polyester polyols according to the invention optionally prepared under amine catalysis may already contain catalytically active amines. However a person skilled in the art can easily determine the amounts of amine catalysts that are advantageously still to be added via suitable experimental series.

Catalysts that may be employed for this purpose further include customary organometallic compounds, preferably organotin compounds such as tin(II) salts of organic carboxylic acids, for example tin(II) acetate, tin(II) octoate, tin(II) ethylhexoate and tin(II) taurate, and the dialkyltin(IV) salts of mineral acids or organic carboxylic acids, for example dibutyltin diacetate, dibutyltin dilaurate, dibutyltin maleate, dioctyltin diacetate and dibutyltin dichloride. In addition, sulfur-containing compounds such as di-n-octyltin mercaptide (U.S. Pat. No. 3,645,927) can also be used.

Catalysts which especially catalyze the trimerization of NCO groups are used for preparing polyurethane materials having high proportions of so-called poly(isocyanurate) structures (“PIR foams”). The preparation of such materials typically employs formulations with significant excesses of NCO groups over OH groups. PIR foams are typically prepared at indexes of 180 to 450, wherein the index is defined as the molar ratio of isocyanate groups to hydroxyl groups multiplied by a factor of 100. Catalysts which contribute to the development of isocyanurate structures are metal salts such as for example potassium or sodium acetate, sodium octoate and amino compounds such as 1,3,5-tris(3-dimethylaminopropyl)-hexahydrotriazine.

The catalysts/catalyst combinations are generally employed in an amount between about 0.001% and 10% by mass, in particular 0.01% to 4% by mass, based on the total amount of compounds having at least two isocyanate-reactive hydrogen atoms.

Additives may optionally also be used in the preparation of the compact or foamed PUR materials. Examples include surface-active additives, such as emulsifiers, foam stabilizers, cell regulators, flame retardants, nucleating agents, oxidation retarders, stabilizers, lubricating and demolding agents, dyes, dispersing aids and pigments. Suitable emulsifiers are for example the sodium salts of castor oil sulfonates or salts of fatty acids with amines such as diethylamine oleate or diethanolamine stearate. Alkali metal or ammonium salts of sulfonic acids such as for instance of dodecylbenzenesulfonic acid or dinaphthylmethanedisulfonic acid or of fatty acids such as ricinoleic acid or of polymeric fatty acids can also be used as surface-active additives. Suitable foam stabilizers particularly include polyethersiloxanes. The construction of these compounds is generally such that copolymers of ethylene oxide and propylene oxide are attached to a polydimethylsiloxane radical. Such foam stabilizers may be reactive towards isocyanates or unreactive towards isocyanates due to etherification of the terminal OH groups. They are described, for example, in U.S. Pat. Nos. 2,834,748, 2,917,480 and 3,629,308. General structures of such foam stabilizers are reproduced in G. Oertel (ed.): “Kunststoff-Handbuch”, Volume VII, Carl-Hanser-Verlag, Munich, Vienna 1993, pp. 113-115. Of particular interest are polysiloxane-polyoxyalkylene copolymers multiply branched via allophanate groups according to DE-A 25 58 523. Other organopolysiloxanes, ethoxylated alkylphenols, ethoxylated fatty alcohols, paraffin oils and cell regulators such as paraffins, fatty alcohols and dimethylpolysiloxanes are also suitable. Also suitable for improving emulsifying action, dispersion of the filler, cell structure and/or for stabilization thereof are oligomeric polyacrylates having polyoxyalkylene and fluoroalkane radicals as side groups. The surface-active substances are typically employed in amounts of 0.01 to 5 parts by mass based on 100 parts by mass of the total amount of compounds having isocyanate-reactive hydrogen atoms. It is also possible to add reaction retarders, for example acidic substances such as hydrochloric acid or organic acids and acid halides, and pigments or dyes and flame retardants known per se, for example tris(chloroethyl) phosphate, triethyl phosphate, tricresyl phosphate or ammonium phosphate and polyphosphate, stabilizers against the influence of aging and weathering, plasticizers and fungicidal and bactericidal substances. Further examples of surface-active additives and foam stabilizers and cell regulators, reaction retarders, stabilizers, flame retardants, plasticizers, dyes and fillers and fungistatic and bacteriostatic substances for optional co-use according to the invention and details concerning use and mode of action of these additives are described in R. Vieweg and A. Höchtlen (Eds.): “Kunststoff-Handbuch”, Volume VII, Carl-Hanser-Verlag, Munich 1966, pp. 103-113.

The PUR materials may be prepared by the processes described in the literature, for example the one-shot process or the prepolymer process, using mixing devices known in principle to those skilled in the art.

### EXAMPLES OF THE PREPARATION OF THE POLYOXYALKYLENE POLYESTER POLYOLS ACCORDING TO THE INVENTION

### Raw Materials Employed:

### Soybean Oil:

Soybean oil (refined, i.e. delecithinated, neutralized, decolorized and steam stripped), obtained from Sigma-Aldrich Chemie GmbH, Munich.

### Irganox®1076:

Octadecyl 3-(3,5-di-tert-butyl-4-hydroxyphenyl)propionate.

Reported percentages are to be understood as meaning reported percentages by mass unless otherwise stated.

### Methods:

### OH Number Determination

OH numbers were determined according to the procedure of DIN 53240.

### Determination of Viscosity

Viscosities were determined according to the specification of DIN 53019 using a Stabinger viscometer (Stabinger SVM 3000, manufacturer: Anton Paar)

### Determination of Turbidity

The determination of turbidity values was in accordance with United States Environmental Protection Agency (USEPA) Method 180.1. The unit of measurement is NTU (nephelometric turbidity units).

### Example 1 (Inventive)

A 10 L laboratory autoclave was charged under a nitrogen atmosphere with 835.5 g of a 70% solution of sorbitol in water, 1099.0 g of sucrose, 153.4 g of distilled water and 10.58 g of imidazole. After closing the autoclave, residual oxygen was removed from it with the stirrer running (200 rpm, gate stirrer) by 5-fold pressurization with nitrogen up to an absolute pressure of 5 bar and subsequent decompression to standard pressure. The reactor was then heated to 110° C. with stirring (200 rpm, gate stirrer). After achieving this temperature the stirrer speed was increased to 450 rpm (corresponding to a power input of about 4.6 W/l, based on the fill level at the end of the metered addition of all reactants). At this temperature initially 1179.3 g of propylene oxide were metered in over a period of altogether 9.2 h. After termination of the metered addition of this first propylene oxide block a postreaction time of 4 h followed. The contents of the autoclave were subsequently stripped by introducing 50 ml of nitrogen per minute via a distribution ring below the liquid level over a period of 3.5 hours at 110° C. with stirring at 100 rpm under vacuum at a pressure of about 125 mbar and the water was thus removed. The autoclave was then cooled to 30° C. and 3138.0 g of soybean oil were added. After closing the autoclave, residual oxygen was removed therefrom during the heating phase by 2-fold pressurization with nitrogen up to an absolute pressure of 5 bar and subsequent evacuation to 10 mbar. After re-attaining the reaction temperature of 110° C. and adjusting the stirrer speed to 450 rpm 300 g of propylene oxide were metered in over a period of 9.72 h. After termination of the metered addition of this second propylene oxide block a postreaction time of 3 h followed. The contents of the autoclave were finally baked out under vacuum at about 5 mbar at reaction temperature over a period of 30 min. 2.534 g of IRGANOX® 1076 were added during the cooling phase. This afforded a product clear at room temperature having a measured OH number of 385 mg KOH/g and a viscosity at 25° C. of 17 550 mPas. The turbidity value was 4.1 NTUs

### Example 2 (Comparative)

A 10 L laboratory autoclave was charged under a nitrogen atmosphere with 835.4 g of a 70% solution of sorbitol in water, 1099.2 g of sucrose, 154.1 g of distilled water and 10.55 g of imidazole. After closing the autoclave, residual oxygen was removed from it with the stirrer running (200 rpm, gate stirrer) by 5-fold pressurization with nitrogen up to an absolute pressure of 5 bar and subsequent decompression to standard pressure. The reactor was then heated to 110° C. with stirring. After achieving this temperature the stirrer speed was increased to 450 rpm (corresponding to a power input of about 4.6 W/l based on the fill level at the end of the metered addition of all reactants). At this temperature initially 1179.3 g of propylene oxide were metered in over a period of altogether 2.7 h. After termination of the metered addition of this first propylene oxide block a postreaction time of 1.33 h followed. The contents of the autoclave were subsequently stripped by introducing 50 ml of nitrogen per minute via a distribution ring below the liquid level over a period of 3.5 hours at 110° C. with stirring at 100 rpm under vacuum at a pressure of about 125 mbar and the water was thus removed. The autoclave was then cooled to 30° C. and 3140.6 g of soybean oil were added. After closing the reactor, residual oxygen was removed during the heating phase by 2-fold pressurization of the autoclave with nitrogen up to an absolute pressure of 5 bar and subsequent evacuation to 10 mbar. After re-attaining the reaction temperature of 110° C. and adjusting the stirrer speed to 450 rpm 300 g of propylene oxide were metered in over a period of 1.22 h. After termination of the metered addition of this second propylene oxide block a postreaction time of 3 h followed. The contents of the autoclave were finally baked out under vacuum at about 5 mbar at reaction temperature over a period of 30 min. 2.496 g of IRGANOX® 1076 were added during the cooling phase. This afforded a biphasic product for which analytical data were not determinable.

### Example 3 (Comparative)

A 10 L laboratory autoclave was charged under a nitrogen atmosphere with 835.2 g of a 70% solution of sorbitol in water, 1199.0 g of sucrose, 150.4 g of distilled water and 10.48 g of imidazole. After closing the autoclave, residual oxygen was removed from it with the stirrer running (200 rpm, gate stirrer) by 5-fold pressurization with nitrogen up to an absolute pressure of 5 bar and subsequent decompression to standard pressure. The reactor was then heated to 110° C. with stirring (200 rpm, gate stirrer). After achieving this temperature the stirrer speed was increased to 450 rpm (corresponding to a power input of about 4.6 W/l based on the fill level at the end of the metered addition of all reactants). At this temperature initially 1000.0 g of propylene oxide were metered in over a period of altogether 10.02 h. After termination of the metered addition of this first propylene oxide block a postreaction time of 2.5 h followed. The contents of the autoclave were subsequently stripped by introducing 50 ml of nitrogen per minute via a distribution ring below the liquid level over a period of 3.1 hours at 110° C. with stirring at 200 rpm under vacuum at a pressure of about 110 mbar and the water was thus removed. The autoclave was then cooled to 30° C. and 3138.1 g of soybean oil were added. After closing the autoclave, residual oxygen was removed therefrom during the heating phase by 2-fold pressurization with nitrogen up to an absolute pressure of 5 bar and subsequent evacuation to 10 mbar. After re-attaining the reaction temperature of 110° C. and adjusting the stirrer speed to 450 rpm 479.2 g of propylene oxide were metered in over a period of 10.23 h. After termination of the metered addition of this second propylene oxide block a postreaction time of 2.18 h followed. The contents of the autoclave were finally baked out under vacuum at about 4 mbar at reaction temperature over a period of 30 min. 2.490 g of IRGANOX® 1076 were added during the cooling phase. This afforded a product turbid at room temperature having a measured OH number of 398 mg KOH/g and a viscosity at 25° C. of 24 150 mPas. The turbidity value was 35.30 NTUs.

### Example 4 (Comparative)

A 10 L laboratory autoclave was charged under a nitrogen atmosphere with 835.4 g of a 70% solution of sorbitol in water, 1098.0 g of sucrose, 150.0 g of distilled water and 10.52 g of imidazole. After closing the autoclave, residual oxygen was removed therefrom with the stirrer running (200 rpm, gate stirrer) by 5-fold pressurization with nitrogen up to an absolute pressure of 5 bar and subsequent evacuation to 10-20 mbar. The reactor was then heated to 110° C. with stirring (200 rpm, gate stirrer). After achieving this temperature the stirrer speed was increased to 450 rpm (corresponding to a power input of about 4.6 W/l based on the fill level at the end of the metered addition of all reactants). At this temperature initially 1000.0 g of propylene oxide were metered in over a period of altogether 10.2 h. After termination of the metered addition of this first propylene oxide block a postreaction time of 1.8 h followed. The contents of the autoclave were subsequently stripped by introducing 50 ml of nitrogen per minute via a distribution ring below the liquid level over a period of 3.1 hours at 110° C. with stirring at 250 rpm under vacuum at a pressure of about 125 mbar and the water was thus removed. The autoclave was then cooled to 40° C. and 3138.0 g of soybean oil were added. After closing the autoclave, residual oxygen was removed therefrom during the heating phase by 5-fold pressurization with nitrogen up to an absolute pressure of 4 bar and subsequent decompression to atmospheric pressure. After re-attaining the reaction temperature of 110° C. and adjusting the stirrer speed to 450 rpm the autoclave was evacuated to 90 mbar and 479.2 g of propylene oxide were metered in over a period of 8.2 h. After termination of the metered addition of this second propylene oxide block a postreaction time of 1.4 h followed. The contents of the autoclave were finally baked out under vacuum at about 30 mbar at reaction temperature over a period of 40 min. 2.526 g of IRGANOX® 1076 were added during the cooling phase. This afforded a product biphasic at room temperature, for which analytical data were not determinable.

### Example 5 (Comparative)

A 10 L laboratory autoclave was charged under a nitrogen atmosphere with 835.3 g of a 70% solution of sorbitol in water, 1098.5 g of sucrose, 150.0 g of distilled water and 10.50 g of imidazole. After closing the autoclave, residual oxygen was removed therefrom with the stirrer running (100 rpm, gate stirrer) by 5-fold pressurization with nitrogen up to an absolute pressure of 5 bar and subsequent evacuation to 200 mbar. The reactor was then heated to 110° C. with stirring (450 rpm, gate stirrer). At this temperature initially 1000.0 g of propylene oxide were metered in over a period of altogether 10.2 hours with stirring at 450 rpm (corresponding to a power input of about 4.6 W/l based on the fill level at the end of the metered addition of all reactants). After termination of the metered addition of this first propylene oxide block a postreaction time of 2.0 h followed. The contents of the autoclave were subsequently stripped by introducing 50 ml of nitrogen per minute via a distribution ring below the liquid level over a period of 3.1 hours at 110° C. with stirring at 100 rpm under vacuum at a pressure of about 125 mbar and the water was thus removed. The autoclave was then cooled to 25° C. and 3137.7 g of soybean oil were added. After closing the autoclave, residual oxygen was removed therefrom during the heating phase by 5-fold pressurization with nitrogen up to an absolute pressure of 5 bar and subsequent decompression to atmospheric pressure. After re-attaining the reaction temperature of 110° C. and adjusting the stirrer speed to 450 rpm 479.3 g of propylene oxide were metered in over a period of 2.0 h. After termination of the metered addition of this second propylene oxide block a postreaction time of 4.45 h followed. The contents of the autoclave were finally baked out under vacuum at about 30 mbar at reaction temperature over a period of 50 min. 2.526 g of IRGANOX® 1076 were added during the cooling phase. This afforded a product biphasic at room temperature, for which analytical data were not determined.

### Example 6 (Comparative)

A 10 L laboratory autoclave was charged under a nitrogen atmosphere with 907.4 g of a 70% solution of sorbitol in water, 1193.5 g of sucrose, 163.0 g of distilled water and 11.46 g of imidazole. After closing the autoclave, residual oxygen was removed therefrom with the stirrer running (250 rpm, gate stirrer) by 4-fold pressurization with nitrogen up to an absolute pressure of 4 bar and subsequent evacuation to 100 mbar. The reactor was then heated to 110° C. with stirring. The stirrer speed was increased to 450 rpm (corresponding to a power input of about 4.6 W/l based on the fill level at the end of the metered addition of all reactants) and at this temperature initially 1086.4 g of propylene oxide were metered in over a period of altogether 10.2 h. After termination of the metered addition of this first propylene oxide block a postreaction time of 1.4 h followed. The contents of the autoclave were subsequently stripped by introducing 50 ml of nitrogen per minute via a distribution ring below the liquid level over a period of 3.1 hours at 110° C. with stirring at 100 rpm under vacuum at a pressure of about 120 mbar and the water was thus removed. The autoclave was then cooled to 20° C. and 3409.2 g of soybean oil were added. After closing the autoclave, residual oxygen was removed therefrom during the heating phase by 5-fold pressurization with nitrogen up to an absolute pressure of 4 bar and subsequent evacuation to 110 mbar. After re-attaining the reaction temperature of 110° C. and adjusting the stirrer speed to 450 rpm 760.6 g of propylene oxide were metered in over a period of 2.2 h. After termination of the metered addition of this second propylene oxide block a postreaction time of 3.8 h followed. The contents of the autoclave were finally baked out under vacuum at about 25 mbar at reaction temperature over a period of 30 min. 3.637 g of IRGANOX® 1076 were added during the cooling phase. This afforded a product clear at room temperature having a measured OH number of 376 mg KOH/g and a viscosity at 25° C. of 14 150 mPas.

### Example 7 (Inventive)

A 10 L laboratory autoclave was charged under a nitrogen atmosphere with 836.6 g of a 70% solution of sorbitol in water, 1098.5 g of sucrose, 150.0 g of distilled water and 10.52 g of imidazole. After closing the autoclave, residual oxygen was removed from it with the stirrer running (100 rpm, gate stirrer) by 5-fold pressurization with nitrogen up to an absolute pressure of 5 bar and subsequent decompression to standard pressure. The reactor was then heated to 110° C. with stirring (100 rpm, gate stirrer). After achieving this temperature the stirrer speed was increased to 450 rpm (corresponding to a power input of about 4.6 W/l based on the fill level at the end of the metered addition of all reactants). At this temperature initially 1279.2 g of propylene oxide were metered in over a period of altogether 10.13 h. After termination of the metered addition of this first propylene oxide block a postreaction time of 1.5 h followed. The contents of the autoclave were subsequently stripped by introducing 50 ml of nitrogen per minute via a distribution ring below the liquid level over a period of 3.5 hours at 110° C. with stirring at 100 rpm under vacuum at a pressure of about 140 mbar and the water was thus removed. The autoclave was then cooled to 25° C. and 3139.0 g of soybean oil were added. After closing the autoclave, residual oxygen was removed therefrom by 5-fold pressurization with nitrogen up to an absolute pressure of 5 bar and subsequent decompression to atmospheric pressure. After re-attaining the reaction temperature of 110° C. and adjusting the stirrer speed to 450 rpm 200.0 g of propylene oxide were metered in over a period of 12.07 h. After termination of the metered addition of this second propylene oxide block a postreaction time of 1.3 h followed. The contents of the autoclave were finally baked out under vacuum at about 30 mbar at reaction temperature over a period of 30 min. 2.52 g of IRGANOX® 1076 were added during the cooling phase. This afforded a product clear at room temperature having a measured OH number of 392 mg KOH/g and a viscosity at 25° C. of 24 750 mPas.

### Example 8 (Inventive)

A 10 L laboratory autoclave was charged under a nitrogen atmosphere with 835.2 g of a 70% solution of sorbitol in water, 1099.1 g of sucrose, 150.0 g of distilled water and 10.55 g of imidazole. After closing the autoclave, residual oxygen was removed therefrom with the stirrer running (200 rpm, gate stirrer) by 3-fold pressurization with nitrogen up to an absolute pressure of 5 bar and subsequent evacuation to about 110 mbar. The reactor was then heated to 110° C. with stirring (200 rpm, gate stirrer). After achieving this temperature the stirrer speed was increased to 350 rpm (corresponding to a power input of about 2.1 W/l based on the fill level at the end of the metered addition of all reactants). At this temperature initially 1179.2 g of propylene oxide were metered in over a period of altogether 10.13 h. After termination of the metered addition of this first propylene oxide block a postreaction time of 1.5 h followed. The contents of the autoclave were subsequently stripped by introducing 50 ml of nitrogen per minute via a distribution ring below the liquid level over a period of 2.0 hours at 110° C. with stirring at 200 rpm under vacuum at a pressure of about 110 mbar and the water was thus removed. The autoclave was then cooled to 20° C. and 3139.2 g of soybean oil were added. After closing the autoclave, residual oxygen was removed therefrom during the heating phase by 4-fold pressurization with nitrogen up to an absolute pressure of 3 bar and subsequent evacuation to 70 mbar. After re-attaining the reaction temperature of 110° C. and adjusting the stirrer speed to 350 rpm 300.0 g of propylene oxide were metered in over a period of 8.6 h. After termination of the metered addition of this second propylene oxide block a postreaction time of 2.1 h followed. The contents of the autoclave were finally baked out under vacuum at about 30 mbar at reaction temperature over a period of 30 min. 2.535 g of IRGANOX® 1076 were added during the cooling phase. This afforded a product clear at room temperature having a measured OH number of 388 mg KOH/g and a viscosity at 25° C. of 24 100 mPas.

### Example 9 (Comparative)

A 10 L laboratory autoclave was charged under a nitrogen atmosphere with 835.4 g of a 70% solution of sorbitol in water, 1099.2 g of sucrose, 150.0 g of distilled water and 10.65 g of imidazole. After closing the autoclave, residual oxygen was removed from it with the stirrer running (100 rpm, gate stirrer) by 5-fold pressurization with nitrogen up to an absolute pressure of 5 bar and subsequent decompression to standard pressure. The reactor was then heated to 110° C. while stirring (450 rpm, gate stirrer, corresponding to a power input of about 4.6 W/l based on the fill level at the end of the metered addition of all reactants). At this temperature initially 1179.2 g of propylene oxide were metered in over a period of altogether 9.33 h. After termination of the metered addition of this first propylene oxide block a postreaction time of 2.5 h followed. The contents of the autoclave were subsequently stripped by introducing 50 ml of nitrogen per minute via a distribution ring below the liquid level over a period of 3.5 hours at 110° C. with stirring at 100 rpm under vacuum at a pressure of about 150 mbar and the water was thus removed. The autoclave was then cooled to 40° C. and 3138.1 g of soybean oil were added. After closing the autoclave, residual oxygen was removed therefrom by 5-fold pressurization with nitrogen up to an absolute pressure of 5 bar and subsequent decompression to atmospheric pressure. Then the reaction temperature was in turn increased to 110° C. and the stirrer speed increased to 450 rpm. Subsequently, 300.1 g of propylene oxide were metered in over a period of 1.25 h. After termination of the metered addition of this second propylene oxide block a postreaction time of 6 h followed. The contents of the autoclave were finally baked out under vacuum at about 33 mbar at reaction temperature over a period of 30 min. 2.531 g of IRGANOX® 1076 were added during the cooling phase. This afforded a product biphasic at room temperature, for which analytical data were not determinable.

### Example 10 (Inventive)

A 10 L laboratory autoclave was charged under a nitrogen atmosphere with 838.2 g of a 70% solution of sorbitol in water, 1098.6 g of sucrose, 150.0 g of distilled water and 10.58 g of imidazole. After closing the autoclave, residual oxygen was removed therefrom with the stirrer running (100 rpm, gate stirrer) by 3-fold pressurization with nitrogen up to an absolute pressure of 5 bar and subsequent evacuation to about 80 mbar. The reactor was then heated to 110° C. with stirring (100 rpm, gate stirrer). After achieving this temperature the stirrer speed was increased to 270 rpm (corresponding to a power input of about 1.1 W/l based on the fill level at the end of the metered addition of all reactants). At this temperature initially 1179.3 g of propylene oxide were metered in over a period of altogether 10.15 h. After termination of the metered addition of this first propylene oxide block a postreaction time of 2.1 h followed. The contents of the autoclave were subsequently stripped by introducing 50 ml of nitrogen per minute via a distribution ring below the liquid level over a period of 3.0 hours at 110° C. with stirring at 200 rpm under vacuum at a pressure of about 125 mbar and the water was thus removed. The autoclave was then cooled to 45° C. and 3137.7 g of soybean oil were added with stirring at 100 rpm. After closing the autoclave, residual oxygen was removed therefrom by 5-fold pressurization with nitrogen up to an absolute pressure of 5 bar and subsequent decompression to atmospheric pressure. Subsequently, the autoclave contents were again heated to 110° C. with stirring at 100 rpm. After re-attaining the reaction temperature of 110° C. and adjusting the stirrer speed to 270 rpm 300.0 g of propylene oxide were metered in over a period of 9.93 h. After termination of the metered addition of this second propylene oxide block a postreaction time of 1.0 h followed. The contents of the autoclave were finally baked out under vacuum at about 25 mbar at reaction temperature over a period of 50 min. 2.533 g of IRGANOX® 1076 were added during the cooling phase. This afforded a product clear at room temperature having a measured OH number of 391 mg KOH/g and a viscosity at 25° C. of 24 150 mPas.

### Example 11 (Comparative)

A 10 L laboratory autoclave was charged under a nitrogen atmosphere with 835.2 g of a 70% solution of sorbitol in water, 1098.5 g of sucrose, 150.0 g of distilled water and 10.53 g of imidazole. After closing the autoclave, residual oxygen was removed from it with the stirrer running (100 rpm, gate stirrer) by 5-fold pressurization with nitrogen up to an absolute pressure of 5 bar and subsequent decompression to standard pressure. The reactor was then heated to 110° C. with stirring. During the heating phase the stirrer speed was increased to 450 rpm (corresponding to a power input of about 4.6 W/l based on the fill level at the end of the metered addition of all reactants). Under these conditions initially 1070.5 g of propylene oxide were metered in over a period of altogether 10.1 h. After termination of the metered addition of this first propylene oxide block a postreaction time of 2 h followed. The contents of the autoclave were subsequently stripped by introducing 50 ml of nitrogen per minute via a distribution ring below the liquid level over a period of 3.0 hours at 110° C. with stirring at 100 rpm under vacuum at a pressure of about 155 mbar and the water was thus removed. The autoclave was then cooled to 40° C. and 3137.7 g of soybean oil were added. After closing the autoclave residual oxygen was removed therefrom by 5-fold pressurization with nitrogen up to an absolute pressure of 5 bar and subsequent decompression to standard pressure. The stirrer speed was increased to 450 rpm again and the reactor contents were heated to 110° C. Under these conditions 200.1 g of propylene oxide were metered in over a period of 8.13 h. After termination of the metered addition of this second propylene oxide block a postreaction time of 0.6 h followed. The contents of the autoclave were finally baked out under vacuum at about 32 mbar at reaction temperature over a period of 90 min. 2.444 g of IRGANOX® 1076 were added during the cooling phase. This afforded a product biphasic at room temperature, for which analytical data were not determinable.

### Example 12 (Inventive)

A 10 L laboratory autoclave was charged under a nitrogen atmosphere with 835.2 g of a 70% solution of sorbitol in water, 1098.6 g of sucrose, 150.1 g of distilled water and 10.59 g of imidazole. After closing the autoclave, residual oxygen was removed from it with the stirrer running (100 rpm, gate stirrer) by 5-fold pressurization with nitrogen up to an absolute pressure of 5 bar and subsequent decompression to standard pressure. The reactor was then heated to 110° C. with stirring. During the heating phase the stirrer speed was increased to 450 rpm (corresponding to a power input of about 4.6 W/l based on the fill level at the end of the metered addition of all reactants). Under these conditions initially 1279.3 g of propylene oxide were metered in over a period of altogether 10.1 h. After termination of the metered addition of this first propylene oxide block a postreaction time of 1.5 h followed. The contents of the autoclave were subsequently stripped by introducing 50 ml of nitrogen per minute via a distribution ring below the liquid level over a period of 3.5 hours at 110° C. with stirring at 100 rpm under vacuum at a pressure of about 135 mbar and the water was thus removed. The autoclave was then cooled to 40° C. and 3137.8 g of soybean oil were added. After closing the autoclave residual oxygen was removed therefrom by 5-fold pressurization with nitrogen up to an absolute pressure of 5 bar and subsequent decompression to standard pressure. The stirrer speed was increased to 450 rpm again and the reactor contents were heated to 110° C. Under these conditions 200.0 g of propylene oxide were metered in over a period of 8.57 h. After termination of the metered addition of this second propylene oxide block a postreaction time of 2.3 h followed. The contents of the autoclave were finally baked out under vacuum at about 30 mbar at reaction temperature over a period of 90 min. 2.444 g of IRGANOX® 1076 were added during the cooling phase. This afforded a product clear at room temperature having a measured OH number of 391 mg KOH/g and a viscosity at 25° C. of 22 750 mPas.

TABLE 1

| | | | | | | | | n(2)/ | n(3-1)/ | Proportion | OH number | |
|---|---|---|---|---|---|---|---|---|---|---|---|---|
| | | | | | | | n(3-2)/ | n(3-2) | n(1) | of fatty | of product | |
| | | n(3-1) | t₁ | n(2) | n(3-2) | t₂ | n(2) t₂ | [mol]/ | [mol]/ | acid ester | (calculated) | |
| Example | n(1) | [mol] | [h] | [mol] | (mol] | [h] | [h] | [mol] | [mol] | [% by mass] | [mg(KOH)/g] | Appearance |
| 1 | 44.93 | 20.3 | 9.2 | 10.7 | 5.17 | 9.7 | 4.7 | 2.07 | 0.45 | 49.7 | 399 | Clear, monophasic |
| 2 (comp.) | 44.94 | 20.3 | 2.7 | 10.71 | 5.17 | 1.2 | 0.59 | 2.07 | 0.45 | 49.7 | 399 | Biphasic |
| 3 (comp.) | 44.93 | 17.22 | 10 | 10.7 | 8.25 | 10.2 | 7.89 | 1.3 | 0.38 | 48.9 | 399 | Turbid |
| 4 (comp.) | 44.91 | 17.22 | 10.2 | 10.7 | 8.25 | 8.2 | 6.32 | 1.3 | 0.38 | 49.7 | 399 | Biphasic |
| 5 (comp.) | 44.92 | 17.22 | 10.2 | 10.7 | 8.25 | 2 | 1.54 | 1.3 | 0.38 | 49.7 | 399 | Biphasic |
| 6 (comp.) | 48.8 | 18.71 | 10.2 | 11.62 | 13.1 | 2.2 | 2.48 | 0.89 | 0.38 | 48 | 386 | Clear, monophasic |
| 7 | 44.95 | 22.02 | 10.1 | 10.7 | 3.44 | 12.1 | 3.89 | 3.11 | 0.49 | 49.7 | 400 | Clear, monophasic |
| 8 | 44.93 | 20.3 | 10.1 | 10.7 | 5.17 | 8.6 | 4.16 | 2.07 | 0.45 | 49.7 | 399 | Clear, monophasic |
| 9 (comp.) | 44.94 | 20.3 | 9.3 | 10.7 | 5.17 | 1.25 | 0.6 | 2.07 | 0.45 | 49.7 | 399 | Biphasic |
| 10 | 44.99 | 20.3 | 10.2 | 10.7 | 5.17 | 9.93 | 4.8 | 2.07 | 0.45 | 49.7 | 400 | Clear, monophasic |
| 11(comp.) | 44.92 | 18.43 | 10.1 | 10.7 | 3.45 | 8.13 | 2.62 | 3.1 | 0.41 | 51.4 | 413 | Biphasic |
| 12 | 44.92 | 22.03 | 10.1 | 10.7 | 3.44 | 8.57 | 2.83 | 3.11 | 0.49 | 49.7 | 399 | Clear, monophasic |

1. A process for preparing a polyoxyalkylene polyester polyol having a calculated OH number of 320 mg KOH/g to 530 mg KOH/g by reacting
an H-functional starter compound (1) having n(1) mol of alcoholic hydroxy groups and/or aminic protons, and
a fatty acid ester (2) having n(2) mol of fatty acid ester groups
with an alkylene oxide (3),
optionally in the presence of a basic catalyst (4) and
optionally in a solvent (5),
wherein the H-functional starter compound (1) comprises one or more compounds,
wherein at least one H-functional starter compound (1) has a melting point of >50.0° C. determined according to the method DIN EN ISO 11357-1:2016,
wherein the fatty acid ester (2) has an OH number of less than 100 mg KOH/g,
wherein the fatty acid ester (2) is used in an amount of at least 40% by mass, based on the total mass of the H-functional starter compound (1), the fatty acid ester (2) and the alkylene oxide (3), and
wherein the process comprises:
(i) providing a system (i) comprising the H-functional starter compound (1) and optionally the basic catalyst (4) optionally in a solvent (5) in a reaction vessel,
(ii) adding n(3−1) mol of a first sub-amount of the alkylene oxide (3) to the system (i) over a period t₁ to form an intermediate (ii),
(iii) optionally removing any solvent (5) present from the intermediate (ii) to form an intermediate (iii),
(iv) adding the fatty acid ester (2) to the intermediate (ii) or to the intermediate (iii) to form an intermediate (iv), wherein n(2) mol of fatty acid ester groups are supplied to the intermediate (ii) or the intermediate (iii),
(v) adding n(3−2) mol of a second sub-amount of the alkylene oxide (3) to the intermediate (iv) over a period t₂ to form the polyoxyalkylene polyester polyol,
wherein (n(3−2)/n(2))·t₂/[h]≥1.0,
wherein n(2)/n(3−2)≥1.05, and
wherein n(3−1)/n(1)≥0.43.

2. The process as claimed in claim 1, wherein the starter compound (1) has a melting point of more than 65° C.

3. The process as claimed in claim 1, wherein the H-functional starter compound (1) having the melting point of >50.0° C. comprises trimethylolpropane, pentaerythritol, sorbitol, sucrose, hydroquinone, catechol, resorcinol, bisphenol F, bisphenol A, 1,3,5-trihydroxybenzene, 1,12-dodecanediol, the isomers of diaminotoluene, the isomers of diaminodiphenylmethane, preferably from the group consisting of pentaerythritol, sorbitol, sucrose, or a combination of any two or more thereof.

4. The process as claimed in claim 1, wherein the fatty acid ester (2) comprises cottonseed oil, peanut oil, coconut oil, linseed oil, palm kernel oil, olive oil, corn oil, palm oil, jatropha oil, rapeseed oil, soybean oil, sunflower oil, herring oil, sardine oil, tallow, or a combination of any two or more thereof.

5. The process as claimed in claim 1, wherein the alkylene oxide (3) comprises propylene oxide and/or ethylene oxide.

6. The process as claimed in claim 1, wherein the reaction in step (i) and/or in step (iv), is carried out in the presence of a basic catalyst (4), wherein the basic catalyst comprises an amine.

7. The process as claimed in claim 6, wherein the amine comprises an aromatic amine comprising imidazole, 1-methylimidazole, 2-methylimidazole, 4(5)-methylimidazole, 2,4(5)-dimethylimidazole, 1-ethylimidazole, 2-ethylimidazole, 1-phenylimidazole, 2-phenylimidazole, 4(5)-phenylimidazole, N,N-dimethylaminopyridine, or a combination of any two or more thereof.

8. The process as claimed in claim 1, wherein fatty acid ester (2) is used in an amount of 40% by mass to 60% by mass, based on the total mass of the H-functional starter compound (1), the fatty acid ester (2) and the alkylene oxide (3).

9. The process as claimed in claim 1, wherein 1.0≤(n(3−2)/n(2))·t₂/[h]≤10.0.

10. The process as claimed in claim 1, wherein 1.05≤n(2)/n(3−2)≤10.0.

11. The process as claimed in claim 1, wherein 0.43≤n(3−1)/n(1)≤0.92.

12. The process as claimed in claim 1, wherein in step i) the system (i) comprises a solvent (5), wherein the solvent (5) comprises water.

13. A polyoxyalkylene polyester polyol obtained by the process as claimed in claim 1.

14. The polyoxyalkylene polyester polyol as claimed in claim 13 having a turbidity number determined by the method specified in the experimental section of ≤30 NTUs.

15. A process for preparing a polyurethanes comprising reacting the polyoxyalkylene polyester polyol as claimed in claim 13 with a polyisocyanate.

16. The process as claimed in claim 9, wherein 1.0≤(n(3−2)/n(2))·t₂/[h]≤8.0.

17. The process as claimed in claim 10, wherein 1.25≤n(2)/n(3−2)≤6.

18. The process as claimed in claim 11, 0.44≤n(3−1)/n(1)≤0.80.

19. The process as claimed in claim 6, wherein the reaction in step (i) is carried out in the presence of the basic catalyst (4).

20. The process as claimed in claim 2, wherein the starter compound (1) has a melting point of 65° C. to 265° C.
